(19) United States
(12) Patent Application Publication
(10) Pub. No.: US 2024/0204571 A1
(43) Pub. Date: Jun. 20, 2024

(54) WIRELESS CHARGING PANEL FOR WIRELESS ELECTRIC CHARGING

(71) Applicant: VETUREX INC, Dubai (AE)

(72) Inventors: Cengiz Hakan Kutluhan, Erlangen (DE); Omer Faruk Yerli, Frankfurt am Main (DE)

(21) Appl. No.: 18/067,783

(22) Filed: Dec. 19, 2022

(51) Int. Cl. H02J 50/20; B60L 53/12; H01Q 21/00; H02J 50/00; H02J 50/40; H02J 50/70

(52) U.S. Cl. CPC H02J 50/20; B60L 53/12; H01Q 21/0006; H02J 50/005; H02J 50/402; H02J 50/70

(57) ABSTRACT

A wireless charging panel configured to electrically connect to a power supply device for wirelessly charging a battery of an electronic device includes a pad element and an electrical connector configured to electrically connect the pad element to the power supply device. The wireless charging panel also includes a wireless energy transfer assembly housed within the pad element. The wireless energy transfer assembly includes a wire coil electrically connected to the electrical connector and configured to receive an electric current from the power supply device and convert the electric current into electromagnetic energy, and an antenna array configured to transmit the electromagnetic energy from the pad element as microwave energy.

### FIELD OF INVENTION

The present application relates to wireless charging of electronic devices. For example, the present application principally is directed toward wireless charging of electric vehicles, although comparable principles may be applied to wireless charging of various types of electronic devices.

### BACKGROUND OF THE INVENTION

The battery charging of an electronic device, while seeming simple at first consideration, often is not actually just a matter of plugging the electronic device into a power supply. The electronic device being charged and the power supply or charging point device need to be able to electrically communicate. There can be both operational and physical impediments to such communication. First, the electronic device being charged and the charging device need to communicate through a compatible language pertaining to operational protocols, such as available charging modes and/or electric power compatibility as to parameters such as operational voltage and current levels. In addition, there often has to be a physical connection between the electronic device being charged and the charging device via a charging cable. Different manufactures, however, may employ different configurations of the physical electrical connector components, which may preclude charging an electronic device using a charging device made by a different manufacturer. Physical electrical connector configurations also can vary across international regions.

Compatibility issues in particular remain an issue in connection with the charging of the batteries of electric vehicles (EVs). The charging mode basically determines how quickly the vehicle battery can be charged depending upon the capabilities of the charging point device or charging station. When it comes to the charging cable for operating the various charging modes, there are numerous different connector types, which can differ depending upon the particular vehicle manufacturer, the geographic region, and/or whether one is using a commercial charging point or charging station versus a home domestic electricity power supply. Four types of electric charging connectors are common for EVs, including two types common for AC charging (Types 1 and 2) and two types common for DC charging (CHAdeMo and CCS). Type 1 is common for U.S. vehicles and includes a single-phase plug that can charge at a speed of up to 7.4 KW. Type 2 is standard for European and Asian vehicles from 2018 onwards and includes a triple-phase plug that can charge at a level of up to 43 KW. CCS is a version of Type 2 with two additional power contacts that allows for very fast charging. CHAdeMO can be found in Asian cars and allows for high charging capacities as well as bidirectional charging between two devices, for example charging a battery of a first EV by battery power of a second EV. It is rare to find all four charging connector types in the same charging station unit, and/or in the same EV.

While the popularity of EVs is growing and standardization of connector types is improving, the physical connection between an EV and the charging point or charging station is still a major disadvantage to owning an EV. Comparable physical compatibility issues may arise in various other fields of electronic devices. For example, portable electronic communication and computer devices (e.g., smart phones, tablets, laptops, and the like) are known to have charging equipment that differs from one manufacturer to another manufacturer. One manner of overcoming the compatibility issues associated with physical electrical connectors is to employ wireless charging whereby electromagnetic energy is transmitted across an air gap from the charging device to the device being charged, and the device being charged converts the received electromagnetic energy into a usable form of electrical energy for charging the battery. Although wireless charging systems are being developed, such systems continue to have deficiencies, and in particular a suitable wireless charging system for EVs has been difficult to achieve.

### SUMMARY OF INVENTION

There is a need in the art, therefore, for an improved system for wireless, contactless charging for electronic devices that is suitable for electric vehicles (EVs) in particular. Described herein is a wireless charging panel for wireless, contactless transfer of electromagnetic energy from the wireless charging panel to a battery of an electronic device, such as an EV. While the present application principally is directed toward the practical usage particularly in wireless, contactless charging of EVs, the present application is not limited to any particular electric charging application and comparable principles may be applied to wireless, contactless charging of a variety of electronic devices. Suitable examples may include, without limitation, wireless charging of electronic devices used in domestic, engineering, industrial, communications, medical, and military environments, and others.

Embodiments of the present application include a wireless charging panel configured to be electrically connected to a power supply device and configured to facilitate wireless charging of a battery of an electronic device opposing the wireless charging panel. The wireless charging panel may be specifically configured to electrically connect to any wired power supply device to make the wired power supply device a wireless power supply without any additional arrangement of parts or assembly. Specifically, the wireless charging panel includes an electrical connector that is configured to electrically connect to a complementary electrical connector of the power supply device, whereby the power supply device may be a charging unit or a charging station such that wireless charging can occur from the power supply device to the electronic device being charged.

The wireless charging panel includes a pad element that is configured to receive electric current from the power supply device via the electric connector of the wireless charging panel, transform the electric current into electromagnetic energy and transmit the electromagnetic energy as microwave energy (i.e., in the spectrum of microwaves) toward the electronic device to be charged. The electronic device to be charged may have a complementary pad element that is configured to receive the microwave energy from pad element of the wireless charging panel, transform the microwave energy back into an electric current and supply the electric current to the battery to charge the battery.

In exemplary embodiments, to accomplish the foregoing the pad element of the wireless charging panel includes a wireless energy transfer assembly including a coil for receiving the electric current from the power supply device and for converting the electric current into electromagnetic energy, and an antenna array for transmitting the electromagnetic energy from the pad element as microwave energy. Transmitting the electromagnetic energy as microwave energy is particularly useful if a distance between the wireless charging panel and the electronic device being charged becomes relatively large, such as may be the case in charging EVs.

Because the wireless charging panel is configured to be electrically connected to the power supply device, the wireless charging panel allows for wireless charging of the battery of the electronic device by the power supply device even if the power supply device natively is not configured for wireless charging, and regardless of physical connection compatibility between the electronic device to be charged and the power supply device.

According to an aspect of the present application, a wireless charging panel is configured to electrically connect to a power supply device for wirelessly charging a battery of an electronic device. The wireless charging panel includes a pad element and an electrical connector configured to electrically connect the pad element to the power supply device. The wireless charging panel also includes a wireless energy transfer assembly housed within the pad element. The wireless energy transfer assembly includes a coil electrically connected to the electrical connector and configured to receive an electric current from the power supply device, and to convert the electric current into electromagnetic energy. The wireless energy transfer assembly also includes an antenna array configured to transmit the electromagnetic energy from the pad element as microwave energy.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting a front view of an exemplary wireless charging panel in accordance with embodiments of the present application.

FIG. 2 is a drawing depicting a perspective view of the wireless charging panel of FIG. 1 adjacent to a power supply device and an electronic device to be charged.

FIG. 3 is a drawing depicting another perspective view of the wireless charging panel of FIG. 1 adjacent to the power supply device and the electronic device to be charged

FIG. 4 is a drawing depicting an exploded view of the wireless charging panel of FIG. 1.

FIG. 5 is a drawing depicting another exploded view of the wireless charging panel of FIG. 1.

FIG. 6 is a drawing depicting a schematic diagram of an antenna assembly of the wireless charging panel of FIG. 1.

### DETAILED DESCRIPTION

Embodiments of the present application will now be described with reference to the drawings, wherein like reference numerals are used to refer to like elements throughout. It will be understood that the figures are not necessarily to scale.

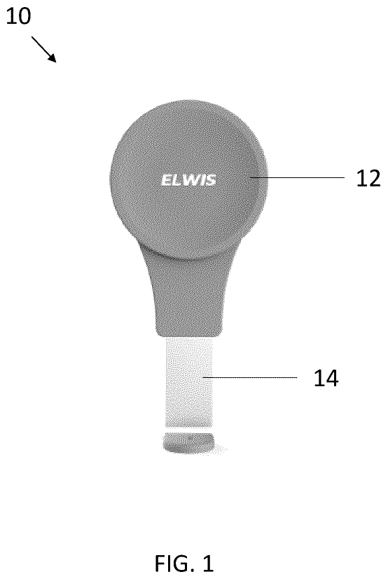

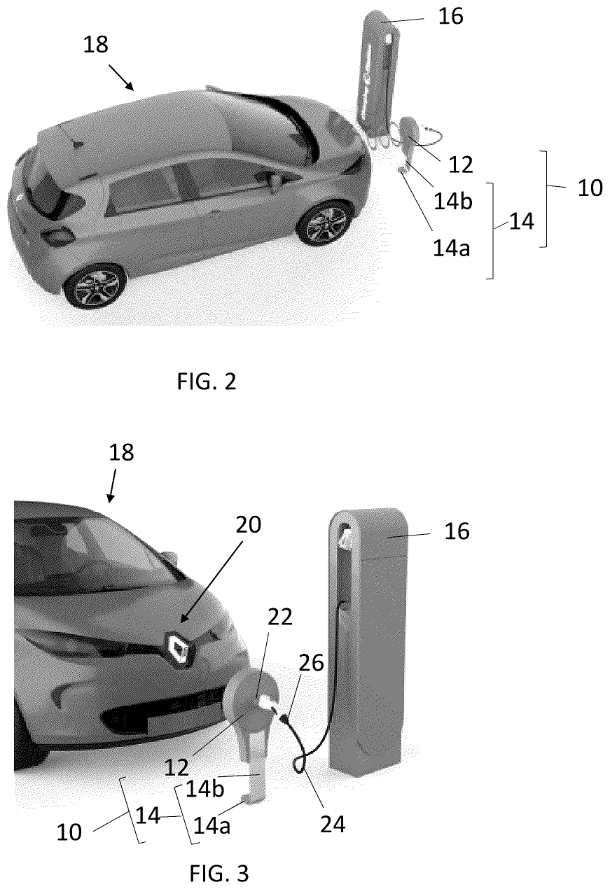

FIG. 1 is a drawing depicting an exemplary wireless charging panel 10 for wireless, contactless charging in accordance with embodiments of the present application. The wireless charging panel 10 includes a pad element 12 and a stand 14 for supporting the pad element 12 at a predetermined distance above a surface on which the wireless charging panel 10 is mounted (e.g., the ground). For contextual purposes and with additional reference to FIGS. 2 and 3, the wireless charging panel 10 may be mounted on and fixed to, for example, the ground adjacent to and spaced apart from a power supply device 16 for wirelessly transmitting electromagnetic energy to an opposing electronic device 18. The electronic device 18 may be, for example, an electric vehicle (EV) having a rechargeable battery and the power supply device 16 may be, for example, a charging unit or a charging station for EVs. By spacing the wireless charging panel 10 apart from the power supply device 16, the wireless charging panel 10 is properly or optimally positioned relative to the electronic device being charged to perform electromagnetic energy transfer with high efficiency and from a closer distance to the electronic device 18 than compared to the power supply device 16. Relatedly, the positioning of the wireless charging panel 10 permits the electronic device 18 to be positioned relative to the pad element 12 for high efficiency electromagnetic energy transfer. Additionally, the wireless charging panel 10 can continue to be used even when the power supply device 16 is under maintenance, since the wireless charging panel 10 is positioned a distance away from the power supply device 16. Moreover, since the wireless charging panel 10 is spaced apart from the power supply device 16, the wireless charging panel 10 may carry a high current to charge high capacity electronic devices, such as long distance EV's.

The wireless charging panel 10 may be positioned at a location to be aligned with a battery or opposing wireless receiving panel of the electronic device 18. For example, the wireless charging panel 10 may be positioned in front of or adjacent a parking space in which the EV (electronic device 18) can park so that the pad element 12 of the wireless charging panel 10 will oppose the battery or opposing wireless receiving panel of the electronic device 18. In the embodiment depicted in FIGS. 2 and 3, for example, the battery or opposing wireless receiving device of the EV may be located at or near and under the hood 20 of the EV 18.

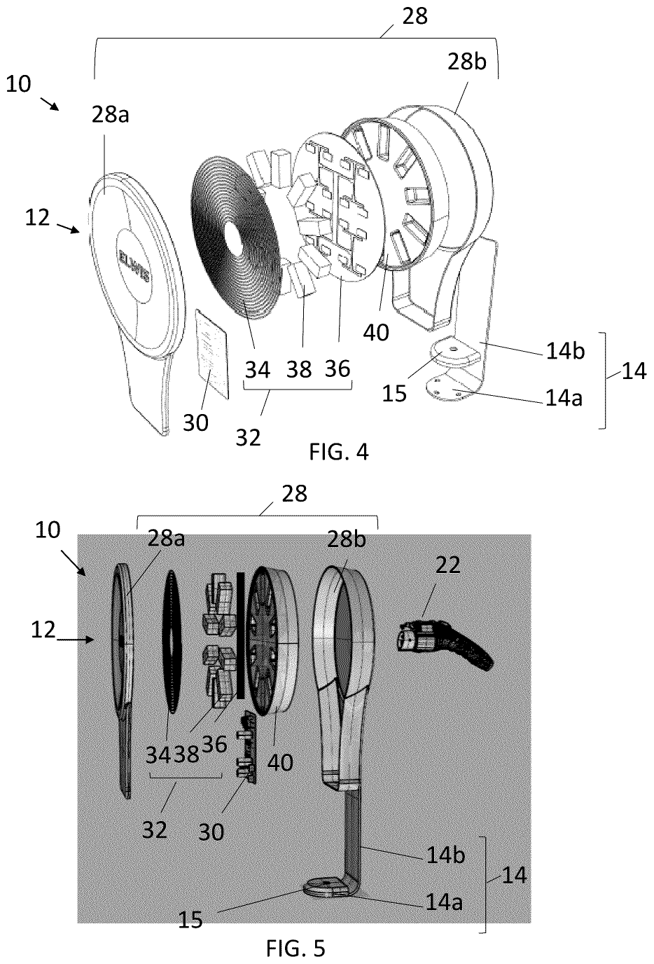

The stand 14 of the wireless charging panel 10 may be made of any suitable rigid material and may have a height that is adapted for any particular application to support the pad element 12 such that it is vertically aligned with the battery or opposing wireless receiving panel of the electronic device 18. For example, as more clearly depicted in FIGS. 4 and 5, the stand 14 may have an L-shape and include a horizontally extending surface fixing portion 14a and a vertically extending pad element fixing portion 14b. The surface fixing portion 14a may include, for example, a through hole 15 for fixing the stand 14 to the surface with, for example, a bolt or other fixing device. The stand also may be formed as an integrated component with a portion of the pad element housing. It will be understood, however, that the precise positioning and height of the pad element 12 and stand 14, respectively, may vary depending on the configuration of the electronic device 18 that is to be charged. In addition, the specific configuration of a pad element with a stand may be modified for any particular application. For example, the wireless charging panel 10 may be fully embedded within the ground, mounted within a frame or container, or otherwise supported by any suitable support structure. Any suitable positioning structure may be employed so long as the resultant position permits proximity of the complementary charging components of the electronic device to be charged.

The wireless charging panel 10 includes an electrical connector 22 that is configured to electrically connect the pad element 12 to the power supply device 16. For example, as depicted best in FIG. 3, a cable 24 having a corresponding electrical connector 26 may extend from the power supply device 16 and be connected to the electrical connector 22 of the wireless charging panel 10. Together, the cable 24, the electrical connector 22 of the wireless charging panel 10 and the corresponding electrical connector 26 of the cable 24 are configured to transmit electric current from the power supply device 16 to the pad element 12 of the wireless charging panel 10. The cable 24 may run externally from the power supply device 16 to the pad element 12 of the wireless charging panel 10, as depicted, or may otherwise run internally within the power supply device 16 and/or through the ground beneath the power supply device 16 and the wireless charging panel 10. In the various embodiments, the electrical connector 22 of the wireless charging panel 10 is accessible from an outside of the pad element 12 such that a user can easily connect and disconnect the pad element 12 from the power supply device 16. The electrical connector 22 of the wireless charging panel 10 may be specifically adapted to have any connector configuration to connect to the corresponding electrical connector 26, depending on its specific type.

With more detailed reference to FIGS. 4 and 5, the pad element 12 may include a case 28 having a front panel 28a forming a front face of the pad element 12 and a rear panel 28b forming a rear face of the pad element 12. The case 28 is configured to contain a circuit board 30 and a wireless energy transfer assembly 32. For example, as depicted the case 28 may form a generally circular cavity for housing the wireless energy transfer assembly 32 and a generally rectangular cavity projecting from the generally circular cavity for housing the circuit board 30. It will be understood, however, that the precise shape and configuration of cavities for housing the circuit board 30 and the wireless energy transfer assembly 32 may vary, depending on the arrangement of components within the case 28.

The front panel 28a and the rear panel 28b may be configured to be secured together at their respective peripheries with, for example, a snap fit or interference fit, or otherwise be fixed together with screws, bolts, or other suitable fixing devices. The electrical connector 22 of the wireless charging panel 10 may be located for connection into the rear panel 28b of the pad element 12, as depicted in FIGS. 2 and 3, or may otherwise be located at another position on the wireless charging panel 10 such that the electrical connector is accessible by the corresponding electrical connector 26 of the cable 22 on an outside of the wireless charging panel 10.

The wireless energy transfer assembly 32 includes a wire coil 34 for converting electric current into electromagnetic energy. The wire coil 34 is therefore configured to be electrically connected to the electrical connector 22 of the wireless charging panel 10 to receive electric current from the electrical connector 22. Specifically, the wire coil 34 is configured to be electrically connected to the circuit board 30, and the circuit board 30 is configured to be electrically connected to the electrical connector 22. The circuit board 30 is configured to receive the electric current from the electrical connector 22, which is received from the power supply device 16, as a direct current (DC) electric current, and convert the DC electric current into an alternating current (AC) electric current. The circuit board 30 is then configured to transmit the AC electric current to the wire coil 34. The wire coil 34 is then configured to convert the AC electric current into the electromagnetic energy. The wire coil 34 may be configured as circular wire windings having an inner diameter and an outer diameter. The wire coil may be configured or shaped as an Archimedean spiral coil.

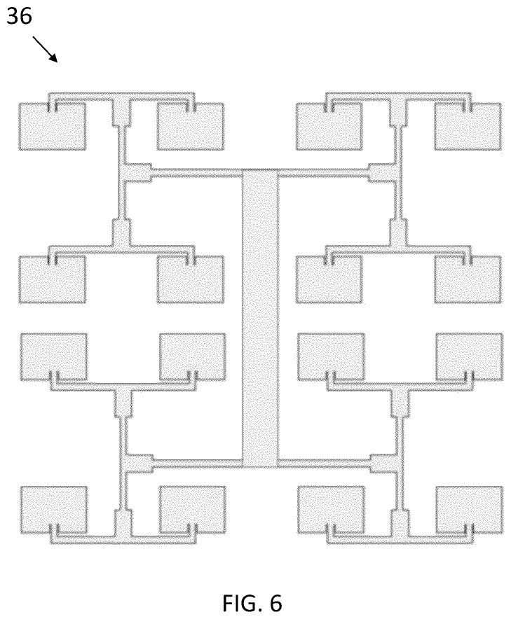

The wireless energy transfer assembly 32 also includes an antenna array 36 for transmitting the electromagnetic energy as microwave energy (i.e., in the spectrum of microwaves). By providing the micro-sized antenna array 36 within the pad element 12, the microwave energy transmitted by the pad element 12 of the wireless charging panel 10 may be kept regular and the efficiency may be kept at the highest level. As depicted in FIG. 6, the antenna array 36 includes a 4-diode arrangement, 2-terminal circuit element rectifier circuit made of semiconductor materials and provides the transmission and direction of electric current over the circuit. The purpose of the 4 rectangular positioning in the system is to allow energy transfer to move in two directions. Depending on the incoming direction, 2 diodes will turn off and allow transmission the other way. That is, the antenna array 36 will enable the wireless charging panel 10 to have bi-directional charging such that a first electronic device at times is the device being charged and a second electronic device acts as the power supply, and at other times vice versa.

Example antenna specifications for the antenna array 36 are set forth in Table I below.

TABLE 1

| Operating Frequency | 3.00 | GHz |
|---|---|---|
| Width of Single Patch (W) | 45 | mm |
| Length of Single Patch (L) | 32 | mm |
| Heights | 60 | mils |
| Feed-line Width | 3.70 | mm |
| Dielectric Constant (€r) | 3.66 | |
| Distance Between Elements | 0.5λ | |
| Input Impedance | 206.9 | Ohm |
| Power Radiated (Watts) | 0.0007 | |
| Effective angle | 0.42 sterdian | |
| Copper Conductivity | 4.7 × 107(s/m) | |
| E (phi) | 325.8 | |
| Gain (dB) | 9.1128 | |
| E (theta) | 144.2 | |
| Metallization Thickness | 50 | μm |

| | |
|---|---|
| Directivity (dB) | 10.3455 |

An additional set of example antenna parameters for the antenna array 36 is set forth in Table II below.

TABLE 2

| | | |
|---|---|---|
| Power Raiated (Watts) | 0.0018 | |
| Efffective angle (Degrees) | 50.33 | |
| Directivity (dB) | 11.56 | |
| Gain (dB) | 10.36 | |
| Max. Intensity | 0.00205 | |
| (Watts/Steradian) | | |
| Angle of U Max. (Theta, | 18.00 | 90 |
| phi) | | |
| E(theta) Max(mag, phase) | 1.24 | 24.67 |
| E(phi) Max(mag, phase) | 0.001125 | 7.81 |
| E(x) Max(mag, phase) | 0.001125 | −172.2 |
| E(y) Max(mag, phase) | 1.18 | 24.67 |
| E(z) Max(mag, phase) | 0.38 | −155.333 |

It will be appreciated that the antenna parameters of Table I and Table II are non-limiting. A nickel-titanium composite has been identified as a preferred material for the antenna array 36. A voltage regulator may be used to stabilize the output voltage. A frequency stabilizer may act as a complementary element to the voltage regulator for creating a balance state in oscillations to keep the frequency of the output voltage constant.

Referring again to FIGS. 4 and 5, the wireless energy transfer assembly 32 may also include an arrangement of a plurality of ferrite bars 38 positioned adjacent to the wire coil 34. The plurality of ferrite bars 38 may be in a wheel-and-spoke pattern in which the wire coil 34 forms the wheel of the wheel-and-spoke pattern and the plurality of ferrite bars 38 form the spokes of the wheel-and-spoke pattern. The plurality of ferrite bars 38 may be fixed into a metallic frame 40 connected to the wire coil 34, which provides for magnetic shielding to limit unwanted electromagnetic radiation transmission into the broader environment. Magnetic shielding is achieved in high amount when the metallic frame is made of, for example, aluminum, cobalt, or cast iron.

Therefore, according to an aspect of this disclosure, a wireless charging panel configured to electrically connect to a power supply device for wirelessly charging a battery of an electronic device includes a pad element and an electrical connector configured to electrically connect the pad element to the power supply device. The wireless charging panel also includes a wireless energy transfer assembly housed within the pad element. The wireless energy transfer assembly includes a wire coil electrically connected to the electrical connector and configured to receive an electric current from the power supply device and convert the electric current into electromagnetic energy, and an antenna array configured to transmit the electromagnetic energy from the pad element as microwave energy.

According to an embodiment of any paragraph(s) of this disclosure, the antenna array includes a 4-diode arrangement, 2-terminal circuit element rectifier circuit.

According to an embodiment of any paragraph(s) of this disclosure, the antenna array is made of semiconductor materials.

According to an embodiment of any paragraph(s) of this disclosure, the antenna array is made of a nickel-titanium composite.

According to an embodiment of any paragraph(s) of this disclosure, the wireless charging panel further includes a stand configured to support the pad element a predetermined distance above a surface on which the wireless charging panel is mounted.

According to an embodiment of any paragraph(s) of this disclosure, the stand includes a horizontally extending surface fixing portion for fixing the wireless charging panel to a surface on which it is configured to be mounted, and a vertically extending pad element fixing portion for fixing the pad element on the stand.

According to an embodiment of any paragraph(s) of this disclosure, the horizontally extending surface fixing portion includes a through hole for fixing the stand to the surface with a fixing device.

According to an embodiment of any paragraph(s) of this disclosure, the electrical connector is accessible from an outside of the pad element.

According to an embodiment of any paragraph(s) of this disclosure, the pad element includes a case and the wireless energy transfer assembly is housed within the case.

According to an embodiment of any paragraph(s) of this disclosure, the case includes a front panel and a rear panel secured together at a periphery of the case.

According to an embodiment of any paragraph(s) of this disclosure, the electrical connector is located on the rear panel.

According to an embodiment of any paragraph(s) of this disclosure, the wireless energy transfer assembly further includes a plurality of ferrite bars positioned adjacent to the coil.

According to an embodiment of any paragraph(s) of this disclosure, the plurality of ferrite bars is fixed into a metallic frame connected to the wire coil for magnetic shielding.

According to an embodiment of any paragraph(s) of this disclosure, the wireless charging panel further includes a circuit board housed within the pad element that is electrically connected to the electrical connector and the wire coil.

According to an embodiment of any paragraph(s) of this disclosure, the circuit board is configured to receive a direct current electric current from the electrical connector, convert the direct current electric current into an alternating current electric current, and transmit the alternating current electric current to the wire coil, and the electric current is received by and converted into electromagnetic energy by the wire coil.

While this disclosure is directed principally toward the charging of electric vehicles (EV's), the principles described herein are not limited to that particular charging application. For example, aspects of the present disclosure may be used in a wide variety of other applications such as domestic, engineering, industrial, communications, medical, and military environments. Aspects of this disclosure may be used in any setting where the wireless charging of a battery or power source is desired.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A wireless charging panel configured to electrically connect to a power supply device for wirelessly charging a battery of an electronic device, the wireless charging panel comprising:
a pad element;
an electrical connector configured to electrically connect the pad element to the power supply device; and
a wireless energy transfer assembly housed within the pad element, the wireless energy transfer assembly including:
a wire coil electrically connected to the electrical connector and configured to receive an electric current from the power supply device and convert the electric current into electromagnetic energy, and
an antenna array configured to transmit the electromagnetic energy from the pad element as microwave energy.

2. The wireless charging panel according to claim 1, wherein the antenna array includes a 4-diode arrangement, 2-terminal circuit element rectifier circuit.

3. The wireless charging panel according to claim 1, wherein the antenna array is made of semiconductor materials.

4. The wireless charging panel according to claim 1, wherein the antenna array is made of a nickel-titanium composite.

5. The wireless charging panel according to claim 1, further comprising a stand configured to support the pad element a predetermined distance above a surface on which the wireless charging panel is mounted.

6. The wireless charging panel according to claim 5, wherein the stand includes a horizontally extending surface fixing portion for fixing the wireless charging panel to a surface on which the wireless charging panel is configured to be mounted, and a vertically extending pad element fixing portion for fixing the pad element on the stand.

7. The wireless charging panel according to claim 6, wherein the horizontally extending surface fixing portion includes a through hole for fixing the stand to the surface with a fixing device.

8. The wireless charging panel according to claim 1, wherein the electrical connector is accessible from an outside of the pad element.

9. The wireless charging panel according to claim 1, wherein the pad element includes a case and the wireless energy transfer assembly is housed within the case.

10. The wireless charging panel according to claim 1, wherein the case includes a front panel and a rear panel secured together at a periphery of the case.

11. The wireless charging panel according to claim 10, wherein the electrical connector is located on the rear panel.

12. The wireless charging panel according to claim 1, wherein the wireless energy transfer assembly further includes a plurality of ferrite bars positioned adjacent to the coil.

13. The wireless charging panel according to claim 12, wherein the plurality of ferrite bars is fixed into a metallic frame connected to the wire coil for magnetic shielding.

14. The wireless charging panel according to claim 1, further comprising a circuit board housed within the pad element that is electrically connected to the electrical connector and the wire coil.

15. The wireless charging panel according to claim 14, wherein the circuit board is configured to receive a direct current electric current from the electrical connector, convert the direct current electric current into an alternating current electric current, and transmit the alternating current electric current to the wire coil, and the electric current is received by and converted into electromagnetic energy by the wire coil.
